(19) United States
(12) Patent Application Publication
(10) Pub. No.: US 2016/0078333 A1
(43) Pub. Date: Mar. 17, 2016

(54) ENCODING AN INFORMATION OBJECT

(71) Applicant: HEWLET-PACKARD DEVELOPMENT COMPANY, L.P., Houston, TX (US)

(72) Inventors: Steven J SIMSKE, FT COLLINS, CO (US); Marie VANS, FI. Collins, CO (US); Matthew E BAKER, Corvallis, OR (US)

(21) Appl. No.: 14/787,679

(22) PCT Filed: Jul. 24, 2013
(86) PCT No.: PCT/US2013/051879

§ 371 Date: Oct. 28, 2015

(51) Int. Cl. G06K 19/06; G06K 1/12; G06K 7/12

(52) U.S. Cl. CPC G06K 19/0614; G06K 19/06037; G06K 7/12; G06K 19/06056; G06K 1/123

(57) ABSTRACT

A first portion of an information object is encoded with first information, where the first information object is recognizable by an information object reader. A second portion of the information object is encoded with second information, where the second information is not recognizable by the information object reader.

### BACKGROUND

Information objects such as barcodes have become increasingly popular as a means for representing data (in machine-readable form) relating to the object to which they are attached, due to their low cost, portability, and high capacity. For example, barcodes may be used to identify and track objects. Barcodes can be scanned by barcode readers and other devices including desktop printers, smartphones, and other portable and/or handheld devices.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 is a block diagram of an information object encoded with information, according to one example;

FIG. 2 is an example of using an encoded information object on a printing surface, according to one example;

FIG. 3 is a flowchart of a method for encoding an information object, according to one example; and

FIG. 4 is a block diagram of a device including memory that contains instructions for encoding an information object, according to one example.

### DETAILED DESCRIPTION

Examples disclosed herein relate to encoding an information object (e.g., a barcode) with information that can be read by a proprietary reader/software code. According to the described examples, the high-contrast (usually black and white) elements of the barcode are readable by a standard barcode reader. The white elements can be substituted by non-white, light colors (e.g., highly saturated colors). These saturated colors are light enough to be read as if they were white elements by the standard barcode reader, but contain information that can only be read by the proprietary reader/software code.

In certain examples, the information can be used to direct a user's interaction with a printing surface such a label, packaging, document, poster, signage, etc. In other examples, the information encoded in the black and white elements of the barcode may direct the user to a location (e.g., a uniform resource locator (URL)), and once the user is authenticated, the information encoded in the colored elements of the barcode may direct the user to a product specific page. In other examples, the information encoded in the colored elements of the barcode may direct the user to one or more portions of a printed material to point an inspection camera at for print inspection/validation. In still other examples, the information may tell the user what part(s) of the package to point at to read a secondary authentication mark. In some examples, the information may connect the user to a consumer location, store/retailer, or other specific product information message. In gaming applications for example, the information may direct the user to a loyalty point, lottery, or gaming feature elsewhere on the package. In forensic applications for example, the information may direct the user to point a forensic device (e.g., a proprietary imaging device, chemical, or other reader) at a part of the package/printed item. Thus, the described solution may be used in a variety of applications such as secure printing, inspection, consumer products, retail-manufacturer, gaming, and forensic applications.

In one example, a method for encoding an information object includes encoding a first portion of an information object with first information, wherein the first information is recognizable by an information object reader. The method also includes encoding a second portion of the information object with second information, where the second information is not recognizable by the information object reader.

In another example, a device includes a processor and a memory that includes instructions executable by the processor. The instructions are executable to encode an information object with first information, where the first information is encoded in a first portion of the information object, and where the first information is decodable by an information object reader. The instructions are also executable to encode the information object with second information, where the second information is encoded in a second portion of the information object, and where the second information is undecodable by the information object reader.

In another example, an information object includes a first portion for receiving first information, where the first information is readable by an information object reader. The information object also includes a second portion for receiving second information, where the second information is readable by a proprietary software program, and where the second information is unreadable by the information object reader.

As used herein an “information object” is any type of standard mark that is used to convey information about a product or service. For example, an information object may be a barcode such as a 2D data matrix, a quick response (QR) code, or any other standard object for presenting information. As used herein “an information object reader” is an electronic device for reading an information object. For example, an information object reader may be a barcode scanner for reading printed barcodes, or any other device (e.g., handheld device, smartphone, camera, PDA, etc) for reading/decoding an information object. As used herein, “information” encoded in a barcode includes any information about a product or service a barcode conveys. The information may direct a user's interaction with the product or service, or may direct the user to a particular location such as a website or a URL. As used herein, “proprietary information” includes information encoded on the barcode that is not recognizable, readable, or decodable by the standard information object reader, but recognizable, readable, or decodable by a custom or proprietary information object reader. As used herein, a “custom or proprietary barcode reader” is any device that includes software program or code that can recognize, read, or decode proprietary information encoded on the information object.

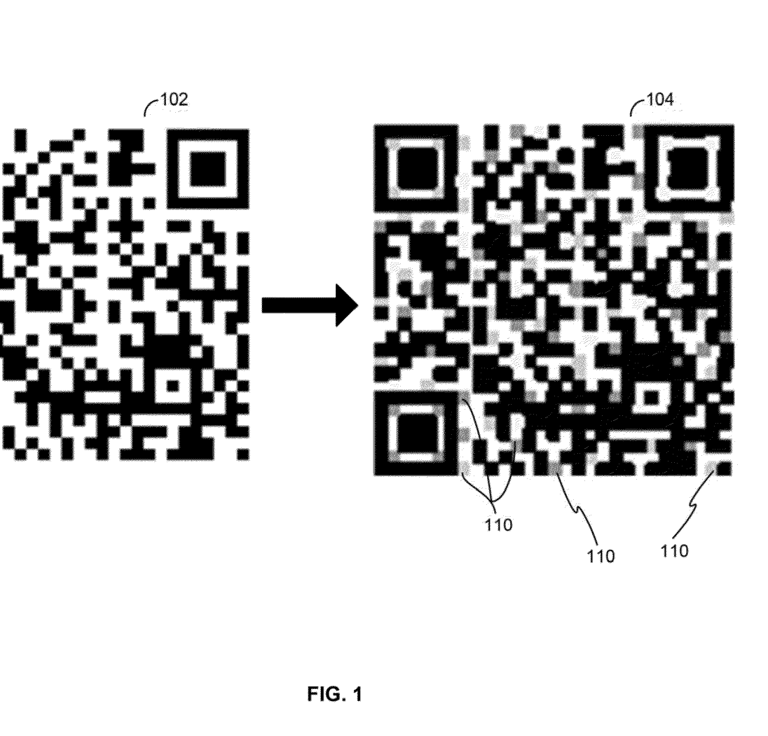

With reference to the figures, FIG. 1 is a block diagram of an information object encoded with information, according to one example. FIG. 1 depicts an information object 102 (e.g., a QR barcode) encoded with information that can be decoded by a standard barcode reader. The barcode 102 includes fields of modules/glyphs/area (e.g., the black and white areas) that have been encoded with information that can be read or decoded by the standard barcode reader. For example, the information encoded in the barcode 102 may direct the user to a location (e.g., a URL or a website), or may provide the user with information about a product upon which the barcode 104 is placed.

The barcode 102 may further be encoded with proprietary information, as shown in barcode 104. The proprietary information encoded to form barcode 104 is unreadable or undecodable by the standard barcode reader. Instead, the barcode 104 is readable/decodable by a custom or proprietary barcode reader or a device (e.g., smartphone, camera) that includes custom software program/code for reading or decoding the proprietary information. As shown in FIG. 1, the barcode 102, at least one of the white portions of the barcode 102 is overprinted with cyan, yellow, and magenta tiles (shown as shaded portions 110) to form barcode 104. It should be noted that the standard barcode reader does not recognize the overprints 110 of barcode 104 and thus reads or interprets the barcode 104 as barcode 102. Thus, the overprints 110 in barcode 104 are invisible to the standard barcode reader but visible to the custom barcode reader. In some examples, the overprints 110 include highly saturated colors such as cyan, magenta, yellow, red, blue, green, or any combination thereof. In some examples, the overprints 110 are seen as “white” by the standard barcode reader, and thus the proprietary information encoded therein cannot be deciphered or understood by the standard barcode reader. It should be noted that the barcode 104 includes the information available in barcode 102 plus the additional proprietary information, thereby enhancing the security and application of the barcode 104.

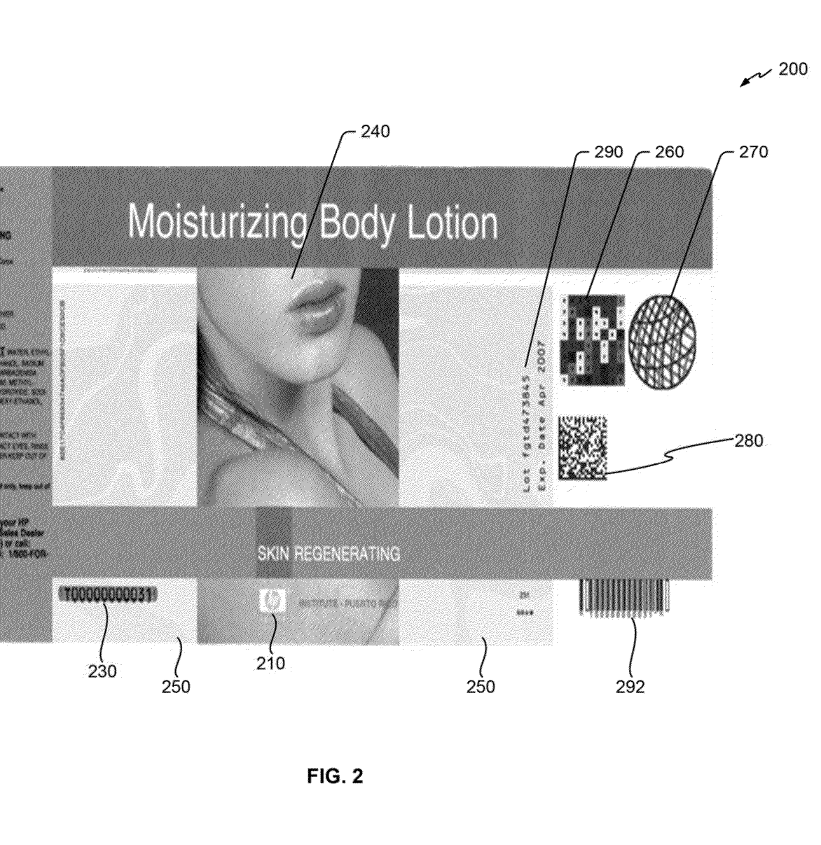

In certain examples, the proprietary information encoded in the barcode 104 may serve as a two-step security function for a user's interaction. To illustrate, the first step may include using the information encoded in the black and white barcode 102 to direct the user to a location (e.g., URL), and the second step may include verifying that the user is in the correct location and using the proprietary information encoded in the colored portions 110 of the barcode 104 for performing the second task. For example, the first step can be directing a user to a login website, and after the user enters their credentials, the proprietary information can be used to perform a second secured task that may include at least one of tracking and tracing the user's actions, authenticating the user, verification, etc. Further, the barcode 104 may be used in a variety of applications such as security printing, inspection, customer-manufacturer interaction, retailer-supply chain interaction, gaming, and forensics. An example application of the barcode 104 is described with reference to FIG. 2.

FIG. 2 is an example of using an encoded information object in a printing surface, according to one example. FIG. 2 depicts a printing surface 200 (e.g., label, packaging, document, poster, signage, etc.) that includes a plurality of different potential variable data targets or regions.

For example, printing surface 200 may include one or more company logos 210, which may hold a watermark, halftone steganographic mark, etc. Printing surface 200 may also include a plurality of text 220 over a background 221; serial number 230 (“T00000000031”); photo image 240; second backgrounds 250, which may contain void pantographs, digital watermarks, steganographic halftones, etc; color tile mark 260; guilloche 270; 2D data matrix barcode 280, lot and expiry date information 290, and 1D barcode 292, for example. Thus, elements 220-292 on the printing surface 200 are variable elements on the same printing surface 200. The 2D barcode 280 can be encoded with proprietary information that directs the user to interrogate another part of the printing surface 200 for another purpose.

To illustrate, the user can be directed to any one or more the marks 210-270 and 290-292 after interrogating a “launch” mark (i.e., the 2D barcode 280 or a first mark without the proprietary information element, where the proprietary information is encoded in the color added to the 2D barcode). From a second mark, the user fulfills a security printing task. For example, the fulfillment can be done directly where the user reads the second mark with a mobile phone application or another application that extracts the contents of the second mark, validates that the content is appropriate for the launch mark, and returns an approval signal to the user. The fulfillment can also be done indirectly, for example, where the user reads the second mark as directed (e.g., the serial number 230 “T00000000031”) and then inputs it as a key for a third mark to which the user is directed, and if the interaction of the two post-launch marks is valid, an approval signal is sent to the user.

The amount of proprietary information that can be encoded into the barcode is dependent on the number of bits that can be coded into a tile of the barcode. For example, the proprietary elements of the barcode may be encoded into the white and highly saturated color tiles within a 2D barcode, and thereafter referred to as “white-as-N-ary” elements (since the white tiles in the 2D barcode are replaced by two or more colors, one of which is white and the others of which are typically highly saturated colors such as printing colors like yellow, magenta, and cyan). The number of bits per tile (i.e., the ‘N’ in “N-ary”) is the log base 2 of the number of colors (including white) that can be written to the white-as-N-ary elements of the barcode. Two such sets of colors and their N-ary values (i.e., number of bits each module represents) are given in Table 1.

TABLE 1
Example color sets that may be used in place of original white modules
for a white-as-N-ary proprietary information content approach in a
2D barcode.

| Color Set | N_{C} = Number of Colors | N = log₂ (N_{C}) |
|---|---|---|
| White, Yellow, Magenta, | 4 | 2.0 |
| Cyan | | |
| White, Yellow, Magenta, | 7 | 2.807 |
| Cyan, Red, Green, Blue | | |

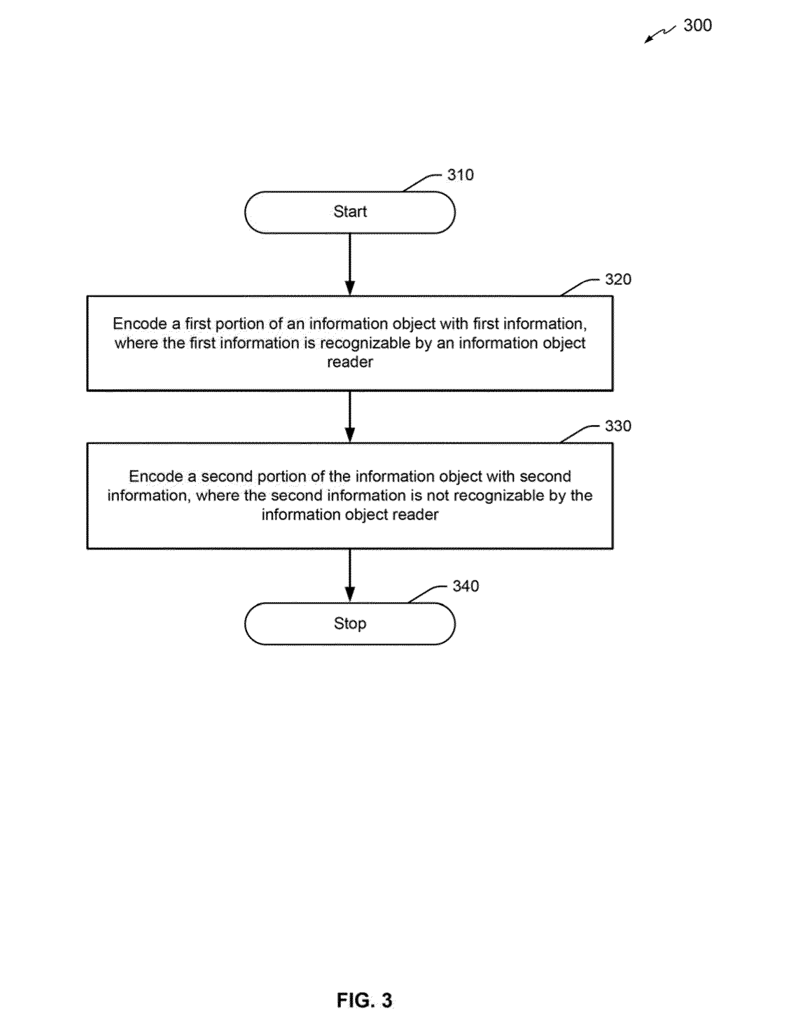

FIG. 3 is a flowchart of a method for encoding an information object, according to one example. Method 300 may be implemented in the form of executable instructions stored on one or more non-transitory machine-readable storage media and/or in the form of electronic circuitry. Method 300 may start in block 310 and proceed to block 320, where a first portion of an information object is encoded with first information. The first information is recognizable by an information object reader. For example, black and white tiles/modules of the barcode may be encoded with information that may direct a user to a location (e.g., a URL). The information encoded in the black and white tiles of the barcode is readable and recognizable by a standard barcode reader.

Method 300 then proceeds to block 330, where a second portion of the information object is encoded with second information. The second information is not recognizable by the information object reader. For example, the barcode may be modified to include proprietary information that is not recognizable/decodable by the barcode reader. For example, the barcode may be modified by adding the proprietary information to colored tiles of the barcode, where one or more combinations of white, yellow, magenta, cyan, red, green, and blue tiles are used to replace the white tiles. Further, the proprietary information is decodable/recognizable only by a custom or proprietary barcode reader that has software program for decoding the proprietary information. For example, during a decoding stage, the custom/proprietary barcode reader decodes the first information (which is also decodable by a standard barcode reader) from the black and white portions of the barcode. Next, the custom/proprietary barcode reader decodes and interprets the second information (or proprietary information) from the colored portions of the barcode. As noted above, the colored portions are light enough to be read as if they were white elements by the standard barcode reader, thus securing the proprietary information contained therein. The proprietary information may direct a user to a second (and secured) product specific page at the location, for example. Method 300 may then proceed to block 340, where the method 300 stops.

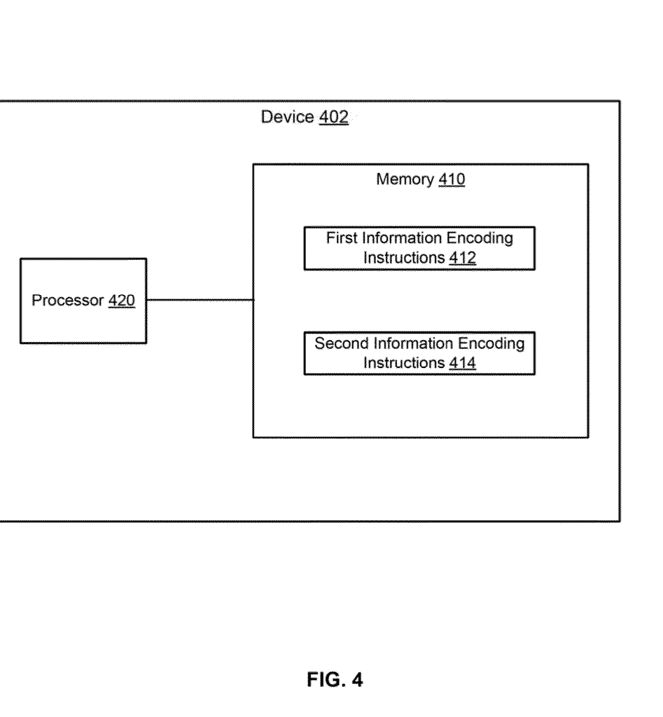

FIG. 4 is a block diagram of a device including memory that contains instructions for encoding an information object, according to one example. Device 402 of FIG. 4 includes a processor 420 coupled to a memory 410. Memory 410 includes instructions 412 and 414 for encoding an information object. Device 402 can be a handheld device, a mobile device, a smartphone, a tablet computing device, a camera, a barcode reader, or any other device.

Processor 420 may be a microprocessor, a semi-conductor based microprocessor, other hardware devices or processing elements suitable for retrieval and execution of instructions 412 and 414 stored in memory 410, or any combination thereof. Memory 410 may include a machine-readable storage medium or any other storage medium. Processor 420 may fetch, decode, and execute instructions stored in memory 410 to implement the functionality described in detail below. As an alternative or in addition to retrieving and executing instructions, processor 420 may include at least one integrated circuit (IC), other control logic, other electronic circuits, or any combination thereof that include a number of electronic components for performing the functionality of instructions 412 and 414 stored in memory 410. Further, processor 420 may include single or multiple cores in a chip, include multiple cores across multiple devices, or any combination thereof.

Memory 410 may be any non-transitory electronic, magnetic, optical, or other physical storage device that contains or stores executable instructions. Thus, memory 410 may be, for example, NVRAM, Random Access Memory (RAM), an Electrically Erasable Programmable Read-Only Memory (EEPROM), a storage drive, a Compact Disc Read Only Memory (CD-ROM), and the like. Further, memory 410 can be computer-readable as well as non-transitory. As described in detail below, memory 410 may be encoded with a series of executable instructions for encoding an information object such as a barcode, a QR code, a security mark, a carrier object, or any identifying object. Other suitable formats of the executable instructions will be apparent to those of skill in the art.

Memory 410 may include first information encoding instructions 412 for encoding the information object with first information. The first information is encoded in a first portion of information object, and is encoded such that the first information can be decoded by a standard information object reader. The first portion of the information object may be a white or black portion of the information object.

Memory 410 may also include second information encoding instructions for encoding the information object with second information. The second information is encoded in a second portion of the information object, and is encoded such that the second information is not decodable by the standard information object reader. Unlike the first information, the second information is only decodable by a custom information object reader with proprietary or custom software code for decoding the second information. The second information may direct a user to a secure area in a location (e.g., URL) and may authenticate/verify the user at the secure area. Further, the second information may be usable to direct the user's interaction with a printing surface (e.g., label, packaging, poster, signage, etc.).

What is claimed is:

1. A method for encoding an information object comprising:
encoding a first portion of an information object with first information, wherein the first information is recognizable by an information object reader; and
encoding a second portion of the information object with second information, wherein the second information is not recognizable by the information object reader.

2. The method of claim 1, wherein the first portion includes black or white elements of the information object, wherein the second portion includes light colored elements of the information object that are not readable by the information object reader, and wherein the information object includes at least one of a barcode, a quick response (QR) code, a security mark, a carrier object, or an identifying object.

3. The method of claim 2, wherein the light colored elements of the information element include light saturated colors comprising at least one of white, cyan, yellow, magenta, red, green, or blue, and wherein the light saturated colors are light enough to be unreadable by the information object reader.

4. The method of claim 3, wherein the light saturated colors are readable by at least one of a custom information object reader or a custom software program, wherein the light saturated colors include the second information.

5. The method of claim 4, wherein the at least one custom information object reader and custom software program is to decode the first information from the first portion of the information object, and to decode the second information from the second portion of the information object.

6. The method of claim 1, wherein the first information is usable to direct a user to a location comprising a uniform resource location (URL), and wherein the second information is usable to authenticate the user at the location and to direct the user to a portion of the location.

7. The method of claim 1, wherein the second information is usable to direct a user's interaction with a printing surface on which the information object is placed, wherein the printing surface includes at least one of a label, a packaging, a document, a poster, and a signage.

8. The method of claim 1, wherein the information object reader includes at least one of a handheld device, a mobile device, a smartphone, or a barcode reader.

9. A device comprising:
a processor; and
a memory comprising instructions executable by the processor to:
encode an information object with first information, wherein the first information is encoded in a first portion of the information object, and wherein the first information is decodable by an information object reader; and
encode the information object with second information, wherein the second information is encoded in a second portion of the information object, and wherein the second information is undecodable by the information object reader.

10. The device of claim 9, wherein the first portion is a black or white portion of the information object, and wherein the second portion is a light or saturated color portion of the information object.

11. The device of claim 10, wherein the light or saturated color portion of the information object is sufficiently light to be invisible to the information object reader, and wherein the light or saturate color portion is visible to a custom information object reader.

12. The device of claim 9, wherein the second information is decodable by a custom information object reader that includes proprietary algorithm for decoding the second information, wherein the second information is to direct a user to a secure location, or to direct the user's interaction with a printing surface, and wherein the printing surface includes at least one of a label, packaging, document, poster, and signage.

13. An information object comprising:
a first portion for receiving first information, wherein the first information is readable by an information object reader; and
a second portion for receiving second information, wherein the second information is readable by a proprietary software program, and wherein the second information is unreadable by the information object reader.

14. The information object of claim 13, wherein the first portion is a black or white portion of the information object, wherein the second portion is a colored portion of the information object, and wherein the information object is at least one of a two-dimensional barcode, a three-dimensional barcode, and a four-dimensional barcode.

15. The information object of claim 13, wherein the first information is to direct a user to a location, and wherein the second information is to authenticate the user at the location and to provide the user secure access to content at the location.
